(19) United States
(12) Patent Application Publication
(10) Pub. No.: US 2018/0117532 A1
(43) Pub. Date: May 3, 2018

(54) SYSTEMS AND METHODS FOR FILTER FLOW MANAGEMENT

(71) Applicant: Cerahelix, Inc., Orono, ME (US)

(72) Inventors: Tyler J. Kirkmann, Orono, ME (US); James V. Banks, Orono, ME (US)

(21) Appl. No.: 15/797,836

(22) Filed: Oct. 30, 2017

Related U.S. Application Data
(60) Provisional application No. 62/414,129, filed on Oct. 28, 2016.

(51) Int. Cl. B01D 61/36

(52) U.S. Cl. CPC B01D 61/362; B01D 61/366; B01D 2317/04; B01D 2317/02; B01D 2313/44

(57) ABSTRACT

A filter flow management system includes a cartridge having an inlet through which fluid flow can be introduced to the cartridge, a plurality of channels situated within the cartridge and designed to remove particulates from the fluid flow, at least one channel being in fluid communication with the inlet to receive the fluid flow, and a reservoir into which fluid flow flowing through the at least one channel can be directed and subsequently redirected into at least one other channel.

### TECHNICAL FIELD

This application claims the benefit of and priority to U.S. Provisional Application No. 62/414,129, filed Oct. 28, 2016, which is hereby incorporated herein by reference in its entirety.

The present disclosure relates generally to filters, and more particularly, to filter flow management systems.

### BACKGROUND

Cross-flow filtration may be used in water treatment to enable molecular separations by passing a continuous feed solution across a surface of a filter medium. In water treatment, as well as some molecular separation applications, a feed solution is delivered to the inlet at a flow rate and a pressure greater than the osmotic pressure of the feed solution, such that a percentage of the feed solution is driven across the filter medium tangentially while a fraction of the feed solution passes through the filter medium.

In another means of molecular separation, pervaporation can be used to selectively remove trace contaminants by partial vaporization of a feed stream which is continuously fed across a surface of the filter medium. In ethyl alcohol pervaporation applications, alcohol concentration can be raised beyond the solution's eutectic point, which provides greater alcohol purity than what is possible by distillation alone.

Average cross-flow velocity is the linear to the flow rate speed at which the feed solution passes into the filter flow channel. For Newtonian Fluids, high average cross-flow velocity and high Reynolds Number reduces filter fouling such as build-up of “filter cakes” or concentration polarization over time during the filtering process and thus, reduces cleaning requirements. High average cross-flow velocity and high Reynolds Number also can improve filter performance and membrane rejection by reducing the concentration polarization layer thickness at the membrane surface.

However, increasing flow rate requires increasing pump capacity, which requires greater equipment expense and greater power demand. Therefore, there is need for an improved filtration system, which enables improved filter flow management that provides high average cross-flow velocity without greater equipment expense and greater power demands.

Moreover, often pervaporation is performed as a batch process whereby a finite volume of ethyl alcohol and water is partially vaporized and is repeatedly circulated over a porous or semi-porous media. Therefore, there is need for an improved pervaporation method which enables the filter flow management that provides successive, sequential de-watering that can be attained by passing the feed solution through a series of membrane flow channels while preventing the solution's re-introduction with the native feed stream.

### SUMMARY

In some embodiments, a filter flow management system is provided. The system includes a cartridge having an inlet through which fluid flow can be introduced to the cartridge. The system also includes a plurality of channels situated within the cartridge and designed to remove particulates from the fluid flow, at least one channel being in fluid communication with the inlet to receive the fluid flow. The system also includes a reservoir into which fluid flow flowing through the at least one channel can be directed and subsequently redirected into at least one other channel.

In some embodiments, at least one of the inlet or the reservoir is integrally formed within the cartridge. In some embodiments, at least one of the channels includes a molecular separation membrane positioned on an inner or outer surface of the channel. In some embodiments, the system also includes an outlet for permitting a fluid concentrate flowing in at least one of the plurality of channels to exit the cartridge, wherein the fluid concentrate comprises a portion of the fluid flow including the particulates removed by the channels. In some embodiments, the system also includes at least one additional reservoir into which fluid flow flowing through at least one of the plurality of channels can be directed and subsequently redirected into at least one additional channel. In some embodiments, the system also includes a housing having the cartridge positioned therein for collecting a filtrate permeating out of the channels, the filtrate comprising a portion of the fluid flow wherein the particulates have been removed by the channels.

In some embodiments, the system also includes a second cartridge arranged in series with the cartridge such that fluid flow exited from an outlet of the cartridge is introduced to a second inlet of the second cartridge. In some embodiments, the system also includes a housing having both the cartridge and the second cartridge positioned therein for collecting a filtrate permeating out of the channels, the filtrate comprising a portion of the fluid flow wherein the particulates have been removed by the channels. In some embodiments, the system also includes a second cartridge arranged in parallel with the cartridge such that the fluid flow is simultaneously introduced to the inlet of the cartridge and a second inlet of the second cartridge. In some embodiments, the system also includes a housing having both the cartridge and the second cartridge positioned therein for collecting a filtrate permeating out of the channels, the filtrate comprising a portion of the fluid flow wherein the particulates have been removed by the channels. In some embodiments, the system also includes a first manifold in fluid communication with a first end of the cartridge. In some embodiments, the system also includes a second manifold in fluid communication with a second end of the cartridge. In some embodiments, the reservoir is formed in at least one of the first manifold or the second manifold. In some embodiments, at least one of the first manifold and the second manifold is removably engageable with the cartridge.

In some embodiments, a method for managing flow in a filtering system is provided. The method includes introducing a fluid flow to a cartridge having a plurality of channels designed to remove particulates from the fluid flow by directing the flow to an inlet of the cartridge. The method also includes, flowing the fluid flow through at least one channel in fluid communication with the inlet. The method also includes, directing the fluid flow into a reservoir in fluid communication with the at least one channel. The method also includes, redirecting, by the reservoir, the fluid flow into at least one other channel.

In some embodiments, the method also includes directing, from at least one of the plurality of channels, the fluid flow into at least one additional reservoir. In some embodiments, the method also includes redirecting, by the at least one additional reservoir, the fluid flow into at least additional channel. In some embodiments, the method also includes collecting, in a housing positioned around the cartridge, a filtrate passing out of the channels, the filtrate comprising a portion of the fluid flow wherein the particulates have been removed by the channels. In some embodiments, the method also includes exiting a fluid concentrate from the cartridge by directing the fluid concentrate from at least one of the plurality of channels to an outlet, wherein the fluid concentrate comprises a portion of the fluid flow including the particulates removed by the channels. In some embodiments, the method also includes introducing the fluid concentrate to a second cartridge by directing the fluid concentrate to a second inlet of the second cartridge. In some embodiments, the method also includes collecting, in a housing positioned around the cartridge and the second cartridge, a filtrate passing out of the channels, the filtrate comprising a portion of the fluid flow wherein the particulates have been removed by the channels. In some embodiments, the filtrate comprises at least one of water or water vapor.

In some embodiments, a filter flow management system is provided. The system includes a first manifold having an inlet extending therethrough to direct a fluid flow into a first group of channels situated within a cartridge having a plurality of channels designed to remove particulates from the fluid flow. The system also includes a second manifold having a first reservoir configured to receive and redirect the fluid flow from the first group of channels into a second group of channels situated in the cartridge. The system also includes an outlet extending through the first or second manifold to exit a fluid concentrate from the system, wherein the fluid concentrate comprises a portion of the fluid flow including the particulates removed by the channels.

In some embodiments, the first and second groups of channels have the same number of channels. In some embodiments, the first and second groups of channels have a different number of channels. In some embodiments, at least one of the plurality of channels includes a molecular separation membrane positioned on an inner or outer surface of the channel. In some embodiments, the system comprises an odd number of reservoirs defined on the first and/or second manifold, and the outlet extends through the second manifold.

### BRIEF DESCRIPTION OF THE DRAWINGS

Illustrative, non-limiting example embodiments will be more clearly understood from the following detailed description taken in conjunction with the accompanying drawings.

FIG. 1A is an exploded view of a filtration system including a filter flow management system in accordance with various embodiments.

FIG. 1B is an exploded view of a housing assembly of a filtration system including a filter flow management system in accordance with various embodiments.

FIG. 1C is an assembly view of a filtration system including a filter flow management system and a housing assembly in accordance with various embodiments.

FIG. 2 is a perspective view of a filter cartridge in accordance with various embodiments.

FIG. 3A is a top view of an inlet manifold in accordance with various embodiments.

FIG. 3B is a cross-sectional view of an inlet manifold in accordance with various embodiments.

FIG. 3C is a side view of an inlet manifold in accordance with various embodiments.

FIG. 4A is a top view of an outlet manifold in accordance with various embodiments.

FIG. 4B is a cross-sectional view of an outlet manifold in accordance with various embodiments.

FIG. 4C is a side view of an outlet manifold in accordance with various embodiments.

FIG. 5A is a bottom view of an end-cap in accordance with various embodiments.

FIG. 5B is a side view of an end-cap in accordance with various embodiments.

FIG. 5C is a cross-sectional view of an end-cap in accordance with various embodiments.

FIG. 6 is a flow chart illustrating a method for managing a filter flow in accordance with various embodiments.

FIG. 7A is a perspective view of a pervaporization system including a filter flow management system in accordance with various embodiments.

FIG. 7B is an exploded interior view of a pervaporization system including a filter flow management system in accordance with various embodiments.

FIG. 8 is an exploded view of another pervaporization system including a filter flow management system in accordance with various embodiments.

FIG. 9 is a schematic view of a prior art system for home water filtration.

FIG. 10 is a schematic view of a system for home water filtration including a filter flow management system in accordance with various embodiments.

FIG. 11A is a schematic view of a prior art parallel flow filtration system.

FIG. 11B is a schematic view of a prior art series flow filtration system.

FIG. 12 illustrates a series flow filtration system including a filter flow management system in accordance with various embodiments.

### DETAILED DESCRIPTION

Various exemplary embodiments will be described more fully hereinafter with reference to the accompanying drawings, in which some example embodiments are shown. The present disclosure may, however, be embodied in many different forms and should not be construed as limited to the example embodiments set forth herein. Rather, these example embodiments are provided so that this disclosure will be thorough and complete, and will fully convey the scope of the present disclosure to those skilled in the art. In the drawings, the sizes and relative sizes of layers and regions may be exaggerated for clarity. Like numerals refer to like elements throughout.

Unless otherwise defined, all terms, including technical and scientific terms, used herein have the same meaning as commonly understood by one of ordinary skill in the art to which this disclosure belongs. For example, when an element is referred to as being “operatively engaged” with another element, the two elements are engaged in a manner that allows fluid communication from one to the other. A “filtrate” refers to the portion of the feed flow that passes through a filter (e.g., membrane) and thus does not include the particulates, contaminants, and/or other materials removed by the filter. The filtrate, in some embodiments, can be a product of interest, secondary product, or unwanted waste. Conversely, a “concentrate” (also referred to as a retentate) refers to the portion of the feed flow that does not pass through the filter and thus includes the particulates, contaminants, and/or other materials retained or removed by the membranes during the filtration process. The concentrate, in some embodiments, can be, for example, a product of interest, secondary product, or unwanted waste. It will be further understood that terms, such as those defined in commonly used dictionaries, should be interpreted as having a meaning that is consistent with their meaning in the context of the relevant art and will not be interpreted in an idealized or overly formal sense unless expressly so defined herein. Additionally, when term “particulate” is used, it also refers to any other contaminant, molecular or biological, which may be of interest in removing from the filtrate and retained in the concentrate.

Embodiments of the present disclosure generally provide flow management for filtration systems. In some embodiments, the systems of the present disclosure can use reservoirs formed at opposing ends of multi-channel filter cartridges to direct and redirect fluid flow through the channels in series.

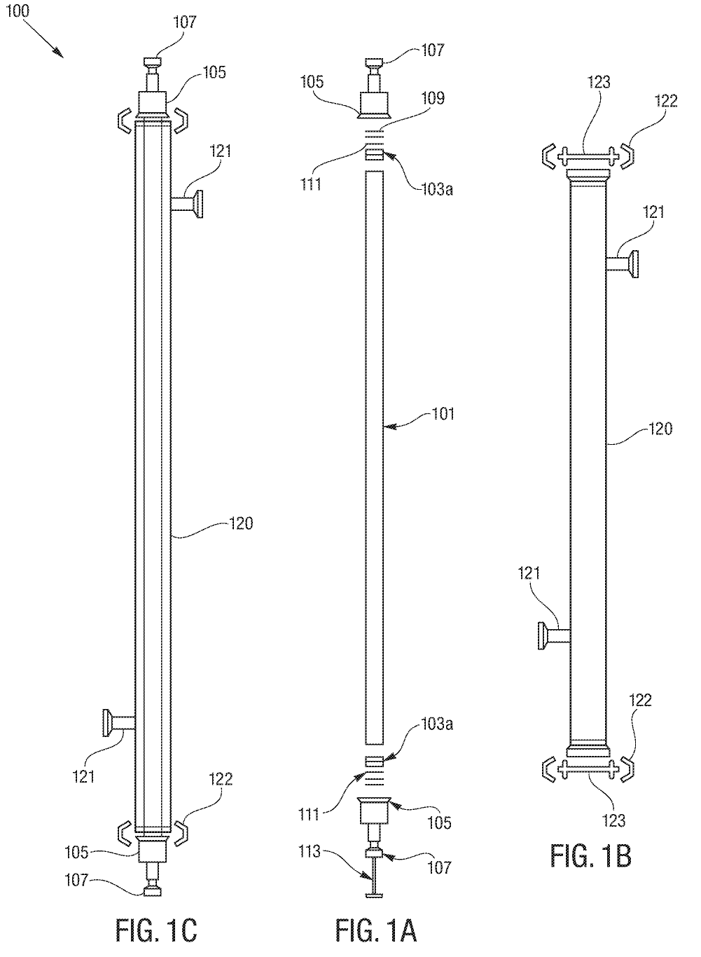

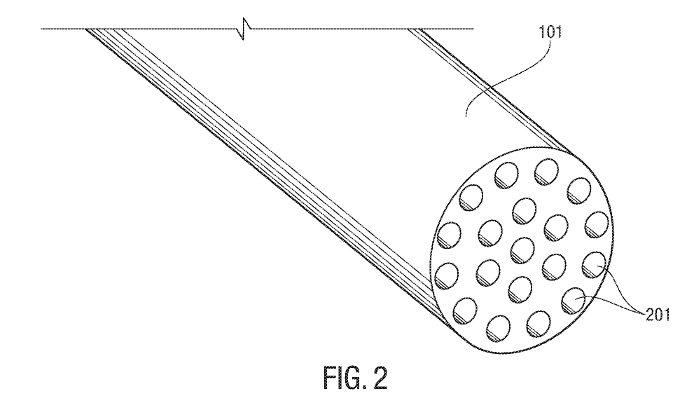

FIG. 1A provides an exploded view of a filtration system assembly 100 in accordance with various embodiments of the present invention. The assembly 100 includes a filter element (cartridge) 101 having at least two filter channels (not shown) situated therein. As shown in FIG. 1A, in some embodiments, the cartridge 101 can be an elongated structure through which the channels extend. Generally, the cartridge 101 can provide filtration for separating a filtrate from a retentate (concentrate) of a fluid flow. Referring now to FIG. 2, in some embodiments, the cartridge 101 can include a plurality of filter channels 201 extending therethrough. Although shown herein as having a circular cross-section, it will be apparent in view of this disclosure that any cross-sectional shape can be used in accordance with various embodiments. For example, in some embodiments, the cartridge 101 can have a rectangular, square, octagonal, hexagonal, star-shaped, any other suitable cross-sectional shape configuration, or combinations thereof. Although the cartridge 101 is shown herein as having nineteen (19) filter channels 201, it will be apparent in view of this disclosure that cartridges 101 in accordance with various embodiments, can have any number of filter channels 201.

In accordance with various embodiments, the cartridge 101 can be constructed of any material having suitable porosity, pore size, and chemical resistance for permitting passage of filtrate therethrough. For example, in some embodiments, the cartridge 101 can be constructed of aluminum oxide ceramic membranes, available from Atech Innovations gmbh, Type 19/33, having 19 channels of 3.3 mm in diameter, 1000 mm length. Other ceramic membrane cartridges from Atech (e.g., having a different number of channels, different diameters, and/or different lengths) or other vendors can also be used.

In some embodiments, the material from which the cartridge 101 is formed can provide filtration of the fluid flow. In some embodiments, the filtration can be provided by one or more membranes positioned on interior or outer surfaces of the filter channels 201. The membranes can be constructed of any suitable material such as a porous ceramic or polymer and can generally include smaller pores than the cartridge 101 material for filtering of smaller contaminants (retentates) of a feed fluid. In some embodiments, the membranes can be provided according to the molecular separation systems and methods described in U.S. Pat. No. 8,426,333, the disclosure of which is incorporated herein in its entirety.

Once the membranes are positioned on the interior and/or outer surfaces of the channels 201, the resulting channels can be used for filtration such as cross-flow filtration. In some embodiments, providing multiple channels 201 within the cartridge 101, rather than a single, larger channel, can increase total membrane surface area while decreasing the size of cartridge 101. During a cross-flow filtration process in which the fluid flow moves parallel to the membrane filtration surface, molecules larger than the pore size of the membrane can pass along the channels 201 of the cartridge 101, while smaller molecules can pass through the membrane as part of the filtrate.

As shown in FIG. 1A, the assembly 100 can also include first and second manifolds 103a, 103b positioned at opposing ends of the cartridge 101 for managing flow through the cartridge 101. As shown in FIG. 1A, in some embodiments, the manifolds 103a, 103b can be separate elements which are permanently or removably attachable to the ends of the cartridge 101. In some embodiments, using removable manifolds 103a, 103b can facilitate access for cleaning of the filter channels 201. In some embodiments, using removable manifolds 103a, 103b can also permit modular reconfiguration of the fluid flowpath by, for example, replacing manifolds 103a, 103b with other manifolds having a different number of reservoirs). However, it will be apparent in view of this disclosure that, in some embodiments, at least one of the first manifold 103a or the second manifold 103b can be integrally formed within the cartridge 101. Such integrated embodiments can promote simplicity and durability of the flow management system by providing a single-piece cartridge 101 having both channels and manifolds 103a, 103b formed therein. In accordance with various embodiments, the first and second manifolds 103a, 103b can be constructed of any suitable material, including, for example, metals, plastics, ceramics, a same material as the cartridge 101, any other suitable material, or combinations thereof.

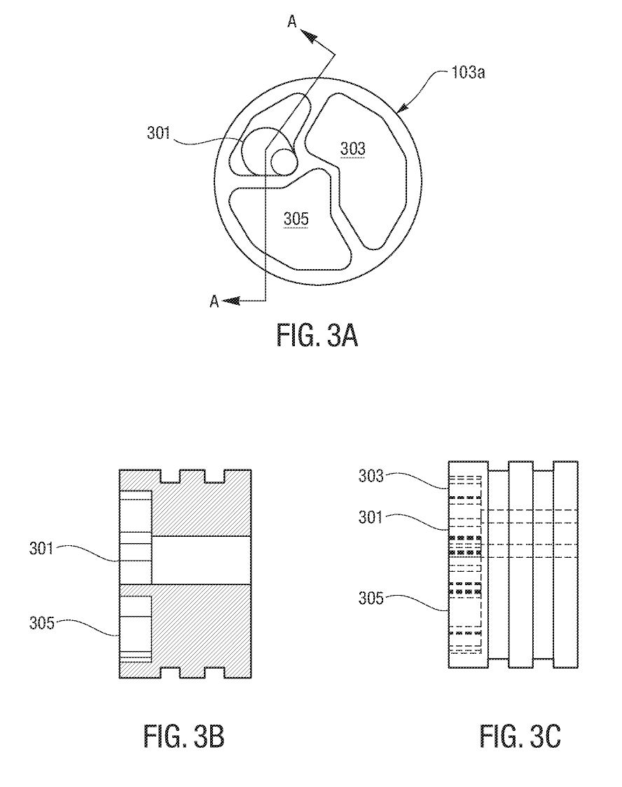

Referring now to FIG. 3A, the first manifold 103a includes an inlet passage 301 extending therethrough. The inlet 301, as shown in FIG. 3B, can extend through the first manifold 103a to permit filter feed flow to enter one or more of the filter channels 201 of the cartridge through the inlet 301. As illustrated in FIGS. 3A and 3B, in some embodiments, the inlet 301 can include a varying cross-sectional flowpath size and shape. Such a configuration can, for example, provide an interface for receiving feed flow from a feed flow delivery system at a first end and an interface for delivering the feed flow to a desired number of channels 201 at a second end. However, it will be apparent in view of this disclosure that, in some embodiments, the inlet 301 can include a constant cross-sectional flowpath size and shape.

Still referring to FIG. 3A, the first manifold 103a can also include a first reservoir 303, and a second reservoir 305 each for receiving flow flowing in one or more channels 201 of the cartridge 101 and redirecting the received flow into one or more additional channels 201 of the cartridge 101. Each of the reservoirs, 303, 305 shown in FIG. 3A, in some embodiments, can be sized and shaped to be placed in sealed alignment with one or more of the channels 201 of the cartridge 101. The reservoirs 303, 305, as shown in FIGS. 3C, can be formed as a recess on a surface of the first manifold 103a. However, it will be apparent in view of this disclosure that, in some embodiments, one or more of the reservoirs 303, 305 can instead be integrally formed within the cartridge 101 such that no manifold 103a is required. Furthermore, it will be apparent in view of this disclosure that any reservoir configuration permitting fluid to be directed into the reservoir from at least one channel 201 and redirected from the reservoir into at least one additional channel 201 can be used in accordance with various embodiments.

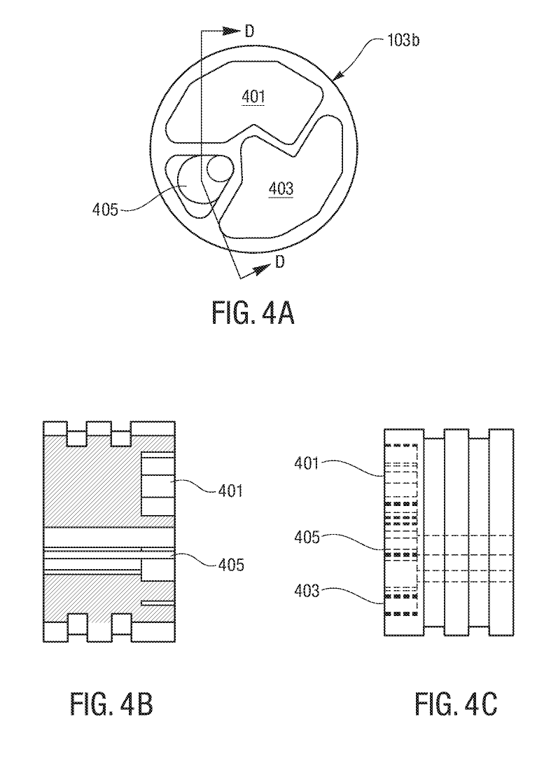

Referring now to FIG. 4A, the second manifold 103b can include a first reservoir 401 and a second reservoir 403, each for receiving flow flowing in one or more channels 201 of the cartridge 101 and redirecting the received flow into one or more additional channels 201 of the cartridge 101. Each of the reservoirs, 401, 403 shown in FIG. 4A, in some embodiments, can be sized and shaped to be placed in sealed alignment with one or more of the channels 201 of the cartridge 101. The reservoirs 401, 403, as shown in FIG. 4C, can be formed as a recess on a surface of the second manifold 103b. However, it will be apparent in view of this disclosure that, in some embodiments, one or more of the reservoirs 401, 403 can instead be integrally formed within the cartridge 101 such that no manifold 103b is required. Furthermore, it will be apparent in view of this disclosure that any reservoir configuration permitting fluid to be directed into the reservoir from at least one channel 201 and redirected from the reservoir into at least one additional channel 201 can be used in accordance with various embodiments.

The second manifold 103b, as shown in FIG. 4B, can also include an outlet 405 extending through the second manifold 103b. As shown in FIG. 4B, the outlet 405 can extend through the second manifold 103b to permit concentrated fluid flow (also referred to as concentrate or retentate as defined above) flowing in one or more of the filter channels to exit the cartridge 101 therethrough. As illustrated in FIGS. 4A and 4B, in some embodiments, the outlet 405 can include a varying cross-sectional flowpath size and shape. Such a configuration can, for example, provide an interface for receiving the concentrate from the one or more channels 201 and direct the concentrate to exit the cartridge 101 into, for example, a waste stream or a recirculation flow. However, it will be apparent in view of this disclosure that, in some embodiments, the outlet 405 can include a constant cross-sectional flowpath size and shape.

Although the first manifold 103a is shown in FIGS. 3A-3C as including the inlet 301 and the second manifold is shown in FIGS. 4A-4C as including the outlet 405, it will be apparent in view of this disclosure that each manifold 103a, 103b, in accordance with various embodiments, can include any number of reservoirs and any combination of an inlet, an outlet, both an inlet and an outlet, or neither an inlet nor an outlet depending on the number of filter channels 201 formed in the cartridge 101 and the number of channels 201 the fluid flow is directed through on each pass through the cartridge 101. In particular, for embodiments configured such that the fluid flow makes an odd number of passes through the cartridge 101, the outlet can be positioned at an opposite end of the cartridge 101 from the inlet. On the other hand, for embodiments configured such that the fluid flow to makes an even number of passes through the cartridge 101, the inlet and the outlet can be positioned on a same end of the cartridge 101.

In use, the first and second manifolds 103a, 103b can be configured to work in concert to direct a fluid flow from the inlet 301 to the outlet 405 by directing the flow, in series, through the channels 201 over multiple “passes” through the cartridge 101. In accordance with various embodiments, the cartridge 101, channels 201, and manifolds 103a, 103b can be configured to direct the flow over as many or as few passes through the cartridge 101 as desired, depending, for example, on the number of channels 201 present in the cartridge 101, the number of reservoirs in each manifold 103a, 103b, a pump capacity of the filtration system, and a flow rate of the feed flow.

In some embodiments, the flow can be directed through a single channel 201 on each pass. In some embodiments, the flow can be directed through multiple channels 201 on each pass. In some embodiments, the flow can be directed through an equal number of channels on each pass. In some embodiments, the flow can be directed through a different number of channels 201 from pass to pass.

For example, in the assembly 100 of FIG. 1A, the cartridge 101 can include 19 channels 201 and the first and second manifolds 103a, 103b can be configured to direct fluid flow through five passes, where the first pass is from the inlet 301 of the first manifold 103a to the first reservoir 401 of the second manifold 103b, the second pass is from the first reservoir 401 of the second manifold 103b to the first reservoir 303 of the first manifold 103a, the third pass is from the first reservoir 303 of the first manifold 103a to the second reservoir 403 of the second manifold 103b, and the fourth pass is from the second reservoir 403 of the second manifold 103b to the second reservoir 305 of the first manifold 103a. For each of the first four passes, the fluid flow can be directed through four filter channels 201 at a time, for a total of 16 channels used. Then, for the fifth and final pass only three (3) channels 201 remain for directing the fluid flow from the second reservoir 305 of the first manifold 103a to the outlet 405 of the second manifold 103b for exiting the cartridge 101 for subsequent disposal, recirculation, and/or additional filtering. In some embodiments, use of a larger number of channels 201 for earlier passes and a smaller number of channels for later passes is beneficial because a volume of filtrate is lost on each pass. Thus, the concentrate flowing on the final pass has a lower volumetric flow rate than the initial flow rate of the feed flow and does not require as many channels 201 to accommodate the flow.

As explained above, it will be apparent in view of this disclosure that, although depicted and described herein as including a cartridge 101 having 19 channels 201 and manifolds 103a, 103b configured to provide fluid flow through five groups of channels 201, any cartridge having any number of channels and any number of reservoirs for directing fluid flow through any number of passes can be used in accordance with various embodiments. It will further be apparent in view of this disclosure that any number of channels 201 can be used for each pass.

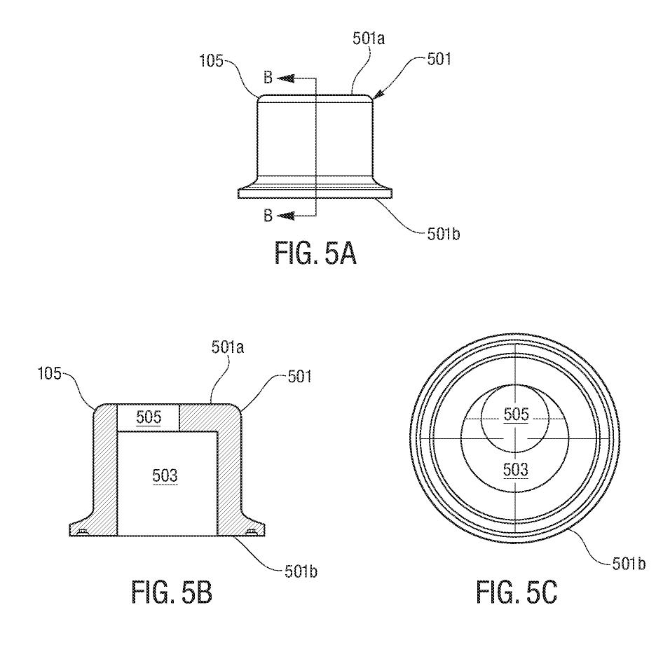

As shown in FIG. 1A, in some embodiments, the assembly 100 can also include one or more end-caps 105 for retaining the manifolds 103a, 103b in sealed alignment with the respective ends of the cartridge 101. Referring now to FIG. 5A, the end-caps 105 can include a body 501 having a first end 501a and a second end 501b, the second end 501b including a flange surrounding the end-cap 105. As shown in FIG. 5B, in some embodiments, the body 501 can define an interior volume 503 open at the second end 501b and sized and shaped to receive one of the manifolds 103a, 103b and at least a portion of the cartridge 101 therein.

In some embodiments, the interior volume 503 can be sized to form a press fit with at least one of the manifold 103a, 103b or the cartridge 101. In some embodiments, the interior volume 503 can be sized to form a loose fit with at least one of the manifold 103a, 103b or the cartridge 101. In such embodiments, one or more seals (not shown) can be provided between an inner diameter of the end-cap 105 and an outer diameter of the cartridge 101 and/or manifold 103a, 103b.

Still referring to FIG. 5B and also to FIG. 5C, in some embodiments, to the extent that fluid is to be delivered or exited from the cartridge 101 via the end-cap 105, the body 501 of the end-cap 105 can further include an aperture 505 defined in the first end 501a, the aperture 505 sized and shaped to receive a fitting 107 for providing connection to a feed source and/or for providing connection to a concentrate drain or return. In some embodiments, the aperture 505 can be sized to form a press fit with the fitting 107. In some embodiments, the fitting 107 can be constructed from a metal, a plastic, a polymer, a rubber, or any other suitable fitting material for connecting to a fluid feed source or a concentrate drain.

Referring again to FIG. 1A, the assembly 100 can also include a compression spring 109 interposed between each end-cap 105 and the manifolds 103a, 103b for biasing the manifolds 103a, 103b against the cartridge 101. In some embodiments, the compression spring 109, by biasing the manifolds 103a, 103b against the cartridge 101, can provide more consistent sealing between the manifolds 103a, 103b and the cartridge 101, in particular the channels 201 of the cartridge 101. The assembly 100 can also include one or more O-rings 111 interposed between each end cap 105 and the manifolds 103a, 103b for providing additional sealing between the end-caps 105 and the manifolds 103a, 103b. Thus, in some embodiments, inclusion of both the compression spring 109 and the O-ring 111 can provide a high pressure sealing to prevent leakage of the fluid flow from between any combination of the end-caps 105, the manifolds 103a, 103b, and the cartridge 101 during operation. In some embodiments, the O-ring 111 can provide a frictional bearing surface between each end cap 105 and the manifolds 103a, 103b, thereby limiting or preventing unintentional rotation of manifolds 103a, 103b relative to the end-caps 105 and/or the cartridge 101. By limiting or preventing unintentional rotation of the manifolds 103a, 103b, the risk of misalignment between the reservoirs 303, 305, 401, 403 and flow channels 201 is reduced, thereby avoiding performance loss during operation.

Accordingly, the fittings 107, end-caps 105, compression springs 109, O-rings 111, manifolds 103a, 103b, and cartridge 101 can be in sealed alignment for maintaining a fluid flowpath between the each fitting 107 and the channels 201 of the cartridge 101. Such a configuration achieves a high pressure fitting, permitting high feed pressures and isolating the feed and concentrate flow streams from the filtrate stream emitted outward through the cartridge 101.

As shown in FIG. 1A, in some embodiments, initial alignment of the fitting 107, end-cap 105, compression spring 109, O-ring 111, manifold 103a, 103b, and cartridge 101 assemblies (hereinafter end-cap assemblies) can be aided by insertion of an alignment pin 113 through the fitting 107, the end-cap 105, the O-ring 111, the compression spring 109, and the manifold 103a, 103b and into a flow channel 201 of the cartridge 101. In some embodiments, a single alignment pin 113 can extend through the cartridge and both end-cap assemblies. In some embodiments, separate alignment pins 113 can be provided for each end-cap assembly. In some embodiments, the alignment pin(s) 113 can be removed after assembly but before the introduction of any fluid to the assembly 100.

Referring now to FIG. 1B, the assembly 100 can also include a housing body 120 surrounding the cartridge for collecting a filtrate stream emitted outward through the cartridge 101. The housing 120, in accordance with some embodiments, can be constructed of any suitable material including, for example, metal, stainless steel, plastic, polymers, other suitable, substantially non-porous materials, or combinations thereof. In accordance with various embodiments, the housing 120 can be constructed of materials chemically compatible with the feed and filtered filtrate (e.g., water, chemicals, or gases). As shown in FIG. 1C, in order to prevent filtrate leakage, protect the filtrate from the surrounding environment, and to further separate the feed stream from the filtrate stream, the housing body 120 can be clamped, using assembly clamp 122, into sealing contact with the flange of the second end 501b of the end-cap 105. Referring again to FIG. 1B, for further sealing, the flange of the end-cap 105 can include a groove configured to receive a gasket 123 for compression between the housing 120 and the flange of the end-cap 105 in order to provide a high pressure seal.

In some embodiments, the filtered filtrate can seep or drip outward from the cartridge 101 into the housing body 120, which can direct the filtrate stream away from the cartridge 101 and through a filtrate port 121. The filtrate can, in some embodiments, be the desired product, a secondary product, or a waste stream. The filtrate port 121, in some embodiments, can be configured to direct the filtered material to a collection and storage location for future use. In some embodiments, the filtrate port 121 can be configured to direct the filtered material directly to a downstream process for subsequent processing. More generally, the filtrate port 121 is configured to direct the filtrate stream away from the cartridge 101 and out of the housing body 120 for collection, recirculation, and/or disposal. The filtrate ports 121 can each be any one or more of a spout, cartridge, pipe, valve, or fitting design suitable for selectively permitting fluid flow therethrough. In some embodiments, one or more of the filtrate ports 121 can be designed to withstand a fluid pressure and temperature consistent with a pressure and temperature of the supply flow, the outflow, and/or the filtrate flow.

In some embodiments (not shown), a filtering system can include more than one cartridge 101. In some embodiments, the filtering system can include a single housing 120 surrounding all of the filter cartridges 101. In some embodiments, the filtering system can include a plurality of housings 120, each surrounding one or more of the cartridges 101. In such embodiments, the fluid flow can be directed through each cartridge 101 in series or in parallel. In some embodiments, each cartridge 101 can include reservoirs for fluid flow management as described above. Regardless, in some embodiments, the cartridges 101 can be connected by a larger scale fluid flow management system having larger reservoirs for redirecting concentrate exiting an outlet 405 of at least one cartridge 101 to at least one additional cartridge 101 for additional processing.

In that regard, in some embodiments, the filter assemblies 100 provide a scalability of a membrane process from discovery scale (testing to determine efficacy, repeatability, as well as the critical measure of performance related to the membrane separation), through pilot and demonstration scale process operations. In particular, such a design advantageously permits a single piece of process equipment to be capable of supporting process development efforts from discovery through demonstration scale operations. Table 1 provides example operating conditions of membrane process equipment when such scalability is employed at different process development stages. For example, as shown below, use of the filter assemblies 100 can result in a 48-fold increase in surface area can be achieve with little more than a 25% increase in pumping rate.

TABLE 1

| | | | | | Pump Rate | |
|---|---|---|---|---|---|---|
| | | | | | Needed to | |
| | | | | | Achieve an | |
| | | Membrane | | Filter Flow | Average | |
| | | Element(s) | Effective | Management | Velocity | |
| | Housing | and | Surface | Employed | Target | Pump |
| Process Scale | Configuration | Dimensions | Area | (Yes/No) | of 3 mps | Capacity |
| Discovery | Single housing | Single | 0.01 m² | No | 5.1 lpm | 0.83 X |
| Scale | | element, | | | | |
| | | one (1) 6 mm | | | | |
| | | diameter flow | | | | |
| | | channel, | | | | |
| | | 500 mm long | | | | |
| Pilot | Single housing | Single | 0.24 m² | Yes | 6.2 | 1 X |
| | | element, | | | | |
| | | nineteen | | | | |
| | | (19) 3.3 mm | | | | |
| | | diameter flow | | | | |
| | | channels, | | | | |
| | | 1200 mm long | | | | |
| Demonstration | Two housings | Two elements, | 0.48 m² | Yes, 2 sets | 6.2 | 1 X |
| | in series | nineteen | | | | |
| | | (19) 3.3 mm | | | | |
| | | diameter flow | | | | |
| | | channels, | | | | |
| | | 1200 mm long | | | | |

Thus, for a given feed pumping system, use of the flow management systems disclosed herein can deliver a higher average cross-flow velocity within the filter channel, compared to conventional single pass filters. Alternatively, with a given pumping target flow rate, a smaller, more affordable and more energy-saving pumping system can be employed.

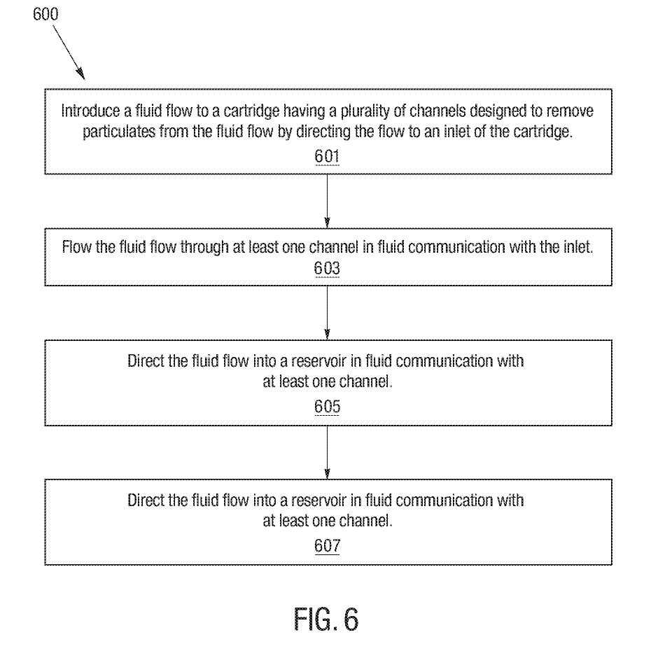

Referring now to FIG. 6, a method 600 is provided for managing a filter flow in accordance with various embodiments. The method 600 includes a step of introducing 601 a fluid flow to a cartridge having a plurality of channels designed to remove particulates from the fluid flow by directing the flow to an inlet of the cartridge. The method 600 also includes a step of flowing 603 the fluid flow through at least one channel in fluid communication with the inlet. The method 600 also includes a step of directing 605 the fluid flow into a reservoir in fluid communication with the at least one channel and a step of redirecting 607, by the reservoir, the fluid flow into at least one other channel.

The step of introducing 601 can include, for example, delivering a fluid flow to the inlet 301 of the first manifold 103a and into at least one channel 201 as explained above with reference to FIGS. 1A-1B. The step of flowing 603 can include, for example, flowing the fluid flow from the inlet 301 of the first manifold 103a through the at least one channel 201 as described above with reference to FIGS. 1A-1B.

The step of directing 605 can include, for example, directing the fluid flow to one of the reservoirs 401, 403 of the second manifold 103b as explained above with reference to FIGS. 1A-1B.

The step of redirecting 607 can include, for example, receiving and redirecting, at the one of the reservoirs 401, 403 of the second manifold 103b, the flow into at least one additional channel 201 as explained above with reference to FIGS. 1A-1B.

### Continuous Pervaporization Process

By way of background, in conventional pervaporation processes, a liquid feed stream is first pre-heated to operating temperature and then routed to a membrane module. A permeate gas is transported through the membrane and vaporized on the permeate side of the membrane and heat is dissipated from the feed. As the partial pressure of the transported component, and with it the driving force for mass transportation, decreases at declining temperature, the feed mixture must be re-heated. In most cases, re-heating takes place outside the modules in separate heat exchangers. Therefore, a batch process must be used, wherein a discrete amount of liquid feed can be processed at any given time. Thus, for high throughput at larger plants and for processes having high permeate rates, it is conventionally necessary to provide for a very large number of small membrane modules with upstream heat exchangers. The vaporous permeate leaving the membrane module is then condensed in an external heat exchanger and a vacuum pump is used only for the removal of inert gasses, having no other function in the process.

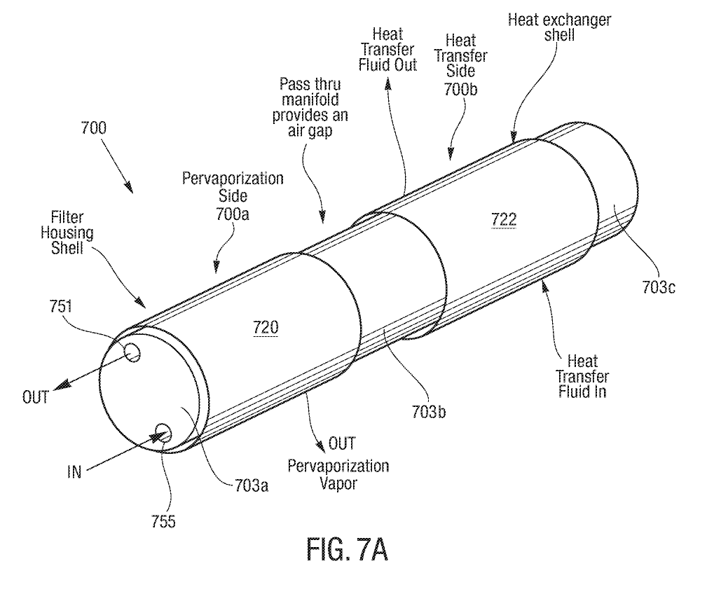

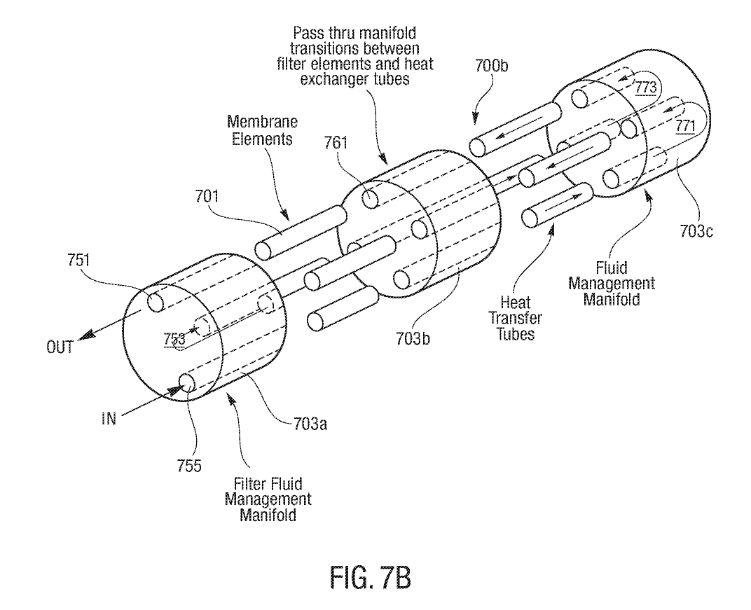

By employing the fluid flow management systems provided herein, a continuous pervaporization process is provided. FIGS. 7A-7B illustrate a continuous process pervaporization system assembly 700 having a pervaporization portion 700a and a heat exchanger portion 700b in accordance with various embodiments. Referring now to FIG. 7B, the assembly 700 includes a first manifold 703a engaged with the pervaporization portion 700a. The first manifold 703a can include an inlet 755, an outlet 751, and a reservoir 753. In some embodiments, the inlet 755, outlet 751, and reservoir 753 of the first manifold 703a can be, for example substantially similar to the inlet 301, outlet 405, and reservoirs 303, 305, 401, 403 of the first and second manifolds 103a, 103b of FIGS. 1A-1B. In some embodiments, the inlet 755 can be configured to direct feed flow into one or more channels of at least one cartridge 701. The cartridge 701, in accordance with various embodiments, can be, for example, substantially similar to cartridge 101 as described above. Within the at least one cartridge 701 in the pervaporization portion 700a, a permeate can be transported through a membrane positioned on an inner or outer surface of the one or more channels and vaporized on the permeate side of the membrane. Upon vaporization of the permeate, heat is dissipated, thus cooling the flow. As shown in FIG. 7A, the vaporized permeate generated in the pervaporization portion 700a can be collected in a pervaporization shell 720 surrounding the cartridges 701 and sealed against the first and second manifolds 703a, 703b.

Referring again to FIG. 7B. In some embodiments, the assembly 700 can also include a second manifold 703b engaged with both the pervaporization portion 700a and the heat exchanger portion 700b. In some embodiments, the second manifold 703b can include a plurality of pass-through channels 761 each in fluid communication with one or more of the cartridges 701. The cooled flow exiting the at least one cartridge 701 can be directed into one or more of the pass-through channels 761 and then directed to one or more heat transfer tubes 705 for reheating in the heat exchanger portion 700b. The heat transfer tubes 705, in accordance with various embodiments, can include one or more channels therein and can be configured to maximize heat transfer between the fluid flow in the heat transfer tubes 705 and heat exchanger fluid flowing externally of the heat transfer tubes 705 in the heat exchanger portion 700b. To that end, in some embodiments, the heat transfer tubes 705 can be constructed of any material suitable for providing efficient heat transfer therethrough such as, for example, stainless steel or other metals.

As shown in FIG. 7A, the heat exchange fluid can be flowed through the heat exchanger portion 700b within a heat exchanger shell 722 surrounding the heat transfer tubes 705 and sealed against the second and third manifolds 703b, 703c. In some embodiments, the heat exchange fluid can be flowed through the heat exchanger shell 722 and then recirculated through a heat source before being returned to the heat exchanger shell 722.

Referring again to FIG. 7B, in some embodiments, the assembly 700 can also include a third manifold 703c engaged with the heat exchanger portion 700b. The third manifold 703c can include one or more reservoirs 771, 773 positioned to redirect flow from the at least one heat transfer tube 705 to at least one additional heat transfer tube 705 such that the flow is further heated. The flow can then be directed through at least one additional pass-through channel 761 and into at least one additional cartridge 701 wherein additional permeate can be transported through the membrane and vaporized on the permeate side of the membrane. Upon vaporization of the permeate, heat is again dissipated, thus cooling the flow. As shown in FIG. 7B, in some embodiments, sufficient heat can remain for the flow to then be directed into the reservoir 753 of the first manifold 703a and redirected into yet another cartridge 701 for further vaporization of the permeate. The flow can then be directed through yet another pass-through channel 761 of the second manifold 703b, through yet another heat transfer tube 705, through yet another reservoir 771, 773 of the third manifold 703c, still another heat transfer tube 705, still another pass-through channel 761, and yet another cartridge 701 for yet further vaporization of the permeate. As shown in FIG. 7B, the flow can then be directed through the outlet 751 to exit the pervaporization system assembly 700. It will be apparent in view of this disclosure that, although shown in FIG. 7B as being redirected in reservoir 753 at the first manifold 703a, it will be understood that, in some embodiments, the fluid flow can instead exit the first manifold after a single pervaporization-heating-heating-pervaporization cycle without additional processing. It will also be apparent in view of this disclosure that, in accordance with various embodiments, the fluid flow can be directed through any number of pervaporization-heating-heating-pervaporization cycles as appropriate.

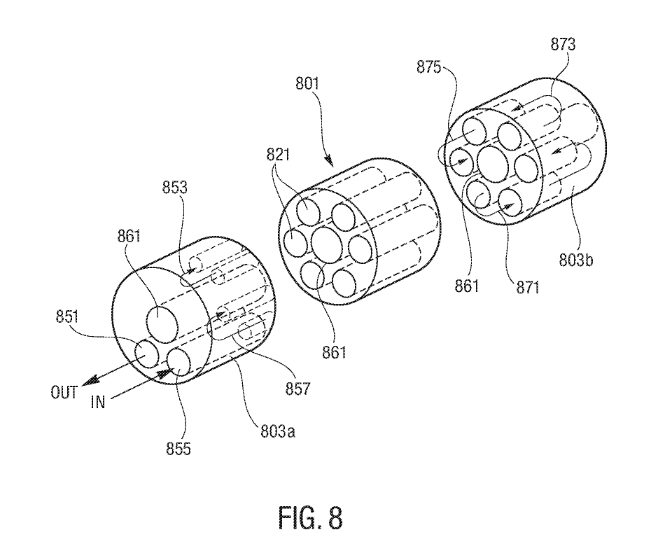

FIG. 8 illustrates a continuous process pervaporization system assembly 800 having one or more heat exchange tubes 861 positioned co-linearly with one or more pervaporization channels 821 in accordance with various embodiments. As shown in FIG. 8, the assembly 800 includes a first manifold 803a engaged with a pervaporization cartridge 801. The first manifold 803a can include an inlet 855, an outlet 851, a first reservoir 853, a second reservoir 857. In some embodiments, the inlet 855, outlet 851, and reservoirs 853, 857 of the first manifold 803a can be, for example substantially similar to the inlet 301, outlet 405, and reservoirs 303, 305, 401, 403 of the first and second manifolds 103a, 103b of FIGS. 1A-1B. In some embodiments, the inlet 855 can be configured to direct pervaporization flow into at least one pervaporization channel 821 of the cartridge 801. Conversely, the outlet 851 can be configured to direct pervaporization flow out of at least one other pervaporization channel 821 to exit the cartridge 101.

Still referring to FIG. 8, in some embodiments, the assembly 800 can also include a second manifold 803b engaged with the cartridge 801. The second manifold 803b can include one or more reservoirs 871, 873, 875 positioned to redirect pervaporization flow from the at least one channel 821 to at least one additional channel 821 such that the flow can make an additional pass through the cartridge 801 for further pervaporization.

The cartridge 801, in accordance with various embodiments, can be, for example, substantially similar to cartridge 101 having channels 201 as described above. Within the at least one cartridge 801, a permeate of the pervaporization flow can be transported through a membrane positioned on an inner or outer surface of the one or more pervaporization channels and vaporized on the permeate side of the membrane. In general, the vaporized permeate generated in the pervaporization channels 821 can be collected in a pervaporization shell or other housing (not shown) surrounding the cartridge(s) 801 and sealed to prevent permeate loss. It will be apparent in view of this disclosure that, although shown in FIG. 8 as including six (6) pervaporization channels 821, resulting in the flow passing through the cartridge six (6) times, any number of pervaporization channels 821 can be used in accordance with various embodiments to permit the flow to make any number of passes through the cartridge 801.

Upon vaporization of the permeate, heat is dissipated, thus cooling the flow. Accordingly, in order to maintain a temperature sufficient for continuous pervaporization in the pervaporization channels 821, the assembly 800 can include one or more heat exchange tubes 861 for transporting a heat exchange fluid through an interior volume of the cartridge 801 to provide radiant heat to the cartridge 801, including the pervaporization channels 821. In some embodiments, heat exchange fluid can be introduced to the heat exchange tube 861 via the first manifold 803a and exited from the heat exchange tube 861 via the second manifold 803b. In some embodiments, in order to maintain a desired temperature, the heat exchange fluid, after exiting the heat exchange tube 861, can be recirculated through a heater or heat exchanger before being reintroduced to the heat exchange tube 861 at the first manifold 803a. Although the cartridge 801 is shown herein as including a single heat exchange tube 861, it will be apparent in view of this disclosure that any number of heat exchange tubes 861 can be included, in accordance with various embodiments, to provide desired heating conditions and desired temperatures in the pervaporization channels 821.

Each heat exchange tube 861, in accordance with various embodiments, can be configured to maximize heat transfer between the heat exchange fluid in the heat exchange tube 861 and the fluid flow in the pervaporization channels 821. To that end, in some embodiments, the heat transfer tube 861 can include a liner positioned on an interior or outer surface thereof. The liner can be constructed of any material suitable for providing efficient heat transfer therethrough such as, for example, stainless steel, other metals, permeable or semi-permeable membranes, or any other suitable material. In some embodiments, the liner can provide a barrier to prevent mass transfer out of the heat exchange tube 861 while permitting heat transfer between the heat exchange tube 861, the cartridge 801, and the pervaporization channels 821. In some embodiments, the liner can permit both mass transfer and heat transfer between the heat exchange tube 861, the cartridge 801, and the pervaporization channels 821.

### Example Embodiments

Thus, the filtration systems having filter flow management systems disclosed herein can be used for energy efficient purification of various gases and fluids. For example, they can be used in purification of alternative fuels from biomass, purification of water produced during oil and gas exploration or pharmaceutical production, and pervaporation processes. Industries in which the composition can be used include oil and petrochemical, coal gasification, pulp and paper, biofuel, syngas and natural gas productions. Additional applications include heavy metal removal, alcohol/water separation, purification and concentration of botanical extracts, dewatering, sugar concentration, carbon monoxide remediation, water purification and desalination. Thus it will be understood that the example embodiments provided below are for illustrative purposes and that many other applications of the technology disclosed herein are possible.

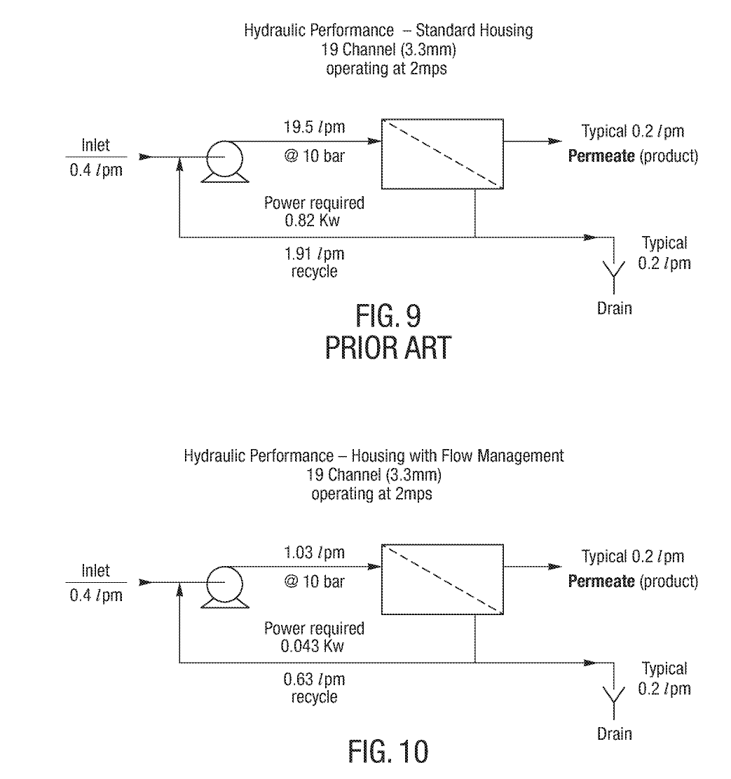

FIG. 9 illustrates a conventional home filtration system and FIG. 10 illustrates a filter flow management system used in connection with a home drinking water filtration system. Home drinking water applications typically require low initial equipment cost and low energy consumption. For example and comparison purposes, FIG. 9 illustrates a conventional 19 filter channel home filtration system and FIG. 10 illustrates a 19 filter channel system including a flow management system.

In FIG. 9, all 19 flow channels operate in parallel requiring a pump capable of delivering 19.5 lpm at a targeted feed pressure of 10 bar (145 psig). Depending upon the pump's operating characteristics the power needed to operate a pump of this capacity may require as much as 0.82 KW. A power requirement of 0.82 KW typically exceeds the power efficiently delivered by compact transformers and low voltage (24 VAC or 24 VDC) motors which in many cases is the preferred power source for consumer water treatment appliances.

By contrast, as shown in FIG. 10, the water treatment system is configured to operate with a flow management system. As shown, the flow management system is configured to permit all 19 flow channels to operate in series. In this configuration, the same permeate (filtered water) flow rate of 0.2 lpm as the system of FIG. 8 can be produced with a pump which requires only 1.03 lpm at a targeted feed pressure of 10 bar (145 psig). Depending upon the pump's operating characteristics, the power needed to operate a pump of this capacity typically requires as little as 0.043 KW. A power requirement of 0.043 KW is well within the power capacity of commercially available transformers and low voltage (24 VAC or 24 VDC) motors which in many cases is the preferred power source for consumer water treatment appliances. Therefore, fluid flow management systems enable the use of a smaller pump package (e.g., for an average crossflow velocity of 2 mps, pump 1.03 lpm versus 19.5 lpm), thereby lowering capital cost of equipment. Additionally, the smaller pump package draws less power, thereby decreasing the operating costs of the system as well.

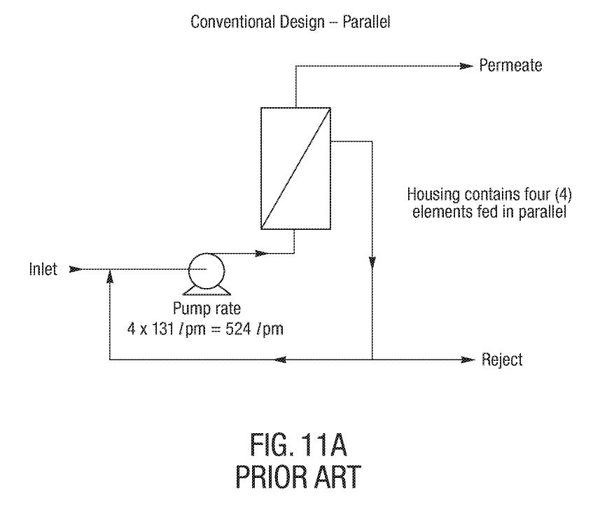

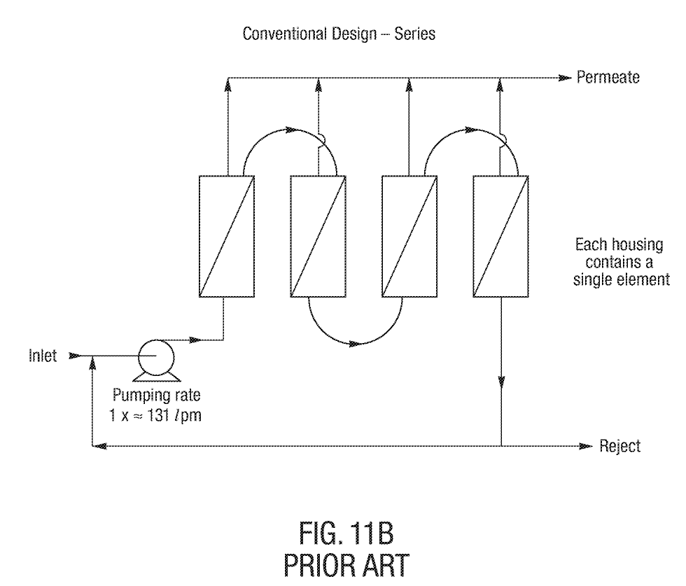

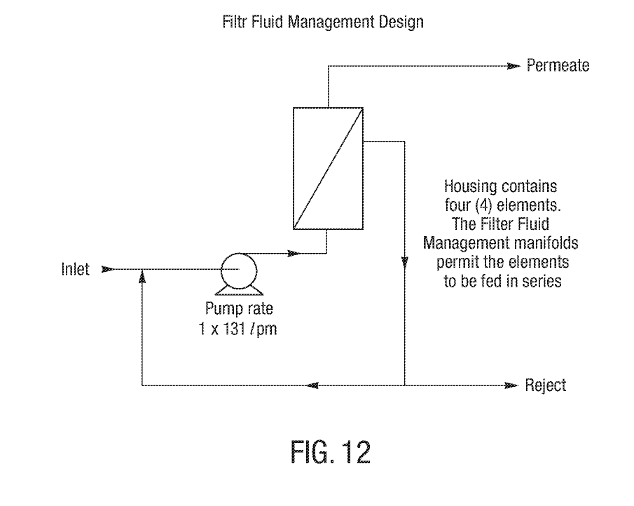

FIG. 11A-11B and FIG. 12 illustrate the efficiencies associated with using a filter flow management systems as described herein. In particular, FIGS. 11A-11B illustrate conventional systems for providing parallel processing of feed flow (FIG. 11A) and series processing of feed flow (FIG. 11B). FIG. 12 illustrates a series processing of feed flow using a filter flow management system as described herein. As explained with greater detail below, use of the filter flow management system as illustrated in FIG. 12 effectively lowers the capital and or operating costs for the system as compared to the conventional parallel and series processing shown in FIGS. 11A-11B.

Each of the conventional systems of FIGS. 11A and 11B includes four (4) filter elements. Each element has 85 flow channels, 3.3 mm diameter and 1.5 m long (approximately 1.32 m² per element). Conventional equipment designs as in FIGS. 11A and 11B call for these four (4) elements to be installed in parallel or series. By conventional means, if the four elements are operated in parallel as in FIG. 11A, all the elements can be contained within a single housing, utilizing common piping, valves and instrumentation. However, since the elements operate in parallel, a feed rate of 524 LPM (4 times the nominal rate of 131 LPM at an average velocity of 3 mps per flow channel) is required compared to the elements operating in series. This increases capital and operating costs associated with pumping larger volumes of fluid.

Alternatively, by conventional means, if the four elements are operated in series as in FIG. 11B, the elements are contained within four (4) independent housings, each with some degree of housing specific piping, valves and instrumentation. Thus, the capital and equipment costs are multiplied by the added complexity and redundancy.

As shown in FIG. 12, the fluid flow management system permits use of a single housing containing four (4) filter elements while operating in series. Thereby the system operates efficiently (lower pumping rates) as a system which operates in series while attaining a low equipment/capital cost due to a simplified design utilizing common piping, valves and instrumentation.

While the present disclosure has been described with reference to certain embodiments thereof, it should be understood by those skilled in the art that various changes may be made and equivalents may be substituted without departing from the true spirit and scope of the disclosure. In addition, many modifications may be made to adapt to a particular situation, indication, material and composition of matter, process step or steps, without departing from the spirit and scope of the present disclosure. All such modifications are intended to be within the scope of the claims appended hereto.

What is claimed is:

1. A filter flow management system comprising:
a cartridge having an inlet through which fluid flow can be introduced to the cartridge;
a plurality of channels situated within the cartridge and designed to remove particulates from the fluid flow, at least one channel being in fluid communication with the inlet to receive the fluid flow; and
a reservoir into which fluid flow flowing through the at least one channel can be directed and subsequently redirected into at least one other channel.

2. The system of claim 1, wherein at least one of the inlet or the reservoir is integrally formed within the cartridge.

3. The system of claim 1, wherein at least one of the channels includes a molecular separation membrane positioned on an inner or outer surface of the channel.

4. The system of claim 1, further comprising an outlet for permitting a fluid concentrate flowing in at least one of the plurality of channels to exit the cartridge, wherein the fluid concentrate comprises a portion of the fluid flow including the particulates removed by the channels.

5. The system of claim 1, further comprising at least one additional reservoir into which fluid flow flowing through at least one of the plurality of channels can be directed and subsequently redirected into at least one additional channel.

6. The system of claim 1, further comprising a housing having the cartridge positioned therein for collecting a filtrate permeating out of the channels, the filtrate comprising a portion of the fluid flow wherein the particulates have been removed by the channels.

7. The system of claim 1, further comprising a second cartridge arranged in series with the cartridge such that fluid flow exited from an outlet of the cartridge is introduced to a second inlet of the second cartridge.

8. The system of claim 7, further comprising a housing having both the cartridge and the second cartridge positioned therein for collecting a filtrate permeating out of the channels, the filtrate comprising a portion of the fluid flow wherein the particulates have been removed by the channels.

9. The system of claim 1, further comprising a second cartridge arranged in parallel with the cartridge such that the fluid flow is simultaneously introduced to the inlet of the cartridge and a second inlet of the second cartridge.

10. The system of claim 9, further comprising a housing having both the cartridge and the second cartridge positioned therein for collecting a filtrate permeating out of the channels, the filtrate comprising a portion of the fluid flow wherein the particulates have been removed by the channels.

11. The system of claim 1, further comprising:
a first manifold in fluid communication with a first end of the cartridge; and
a second manifold in fluid communication with a second end of the cartridge.

12. The system of claim 11, wherein the reservoir is formed in at least one of the first manifold or the second manifold.

13. The system of claim 11, wherein at least one of the first manifold and the second manifold is removably engageable with the cartridge.

14. A method for managing flow in a filtering system comprising:
introducing a fluid flow to a cartridge having a plurality of channels designed to remove particulates from the fluid flow by directing the flow to an inlet of the cartridge;
flowing the fluid flow through at least one channel in fluid communication with the inlet;
directing the fluid flow into a reservoir in fluid communication with the at least one channel; and
redirecting, by the reservoir, the fluid flow into at least one other channel.

15. The method of claim 14, further comprising:
directing, from at least one of the plurality of channels, the fluid flow into at least one additional reservoir; and
redirecting, by the at least one additional reservoir, the fluid flow into at least additional channel.

16. The method of claim 14, further comprising collecting, in a housing positioned around the cartridge, a filtrate passing out of the channels, the filtrate comprising a portion of the fluid flow wherein the particulates have been removed by the channels.

17. The method of claim 14, further comprising exiting a fluid concentrate from the cartridge by directing the fluid concentrate from at least one of the plurality of channels to an outlet, wherein the fluid concentrate comprises a portion of the fluid flow including the particulates removed by the channels.

18. The method of claim 17, further comprising introducing the fluid concentrate to a second cartridge by directing the fluid concentrate to a second inlet of the second cartridge.

19. The method of claim 18, further comprising collecting, in a housing positioned around the cartridge and the second cartridge, a filtrate passing out of the channels, the filtrate comprising a portion of the fluid flow wherein the particulates have been removed by the channels.

20. The method of claim 14, wherein the filtrate comprises at least one of water or water vapor.

21. A filter flow management system comprising:
a first manifold having an inlet extending therethrough to direct a fluid flow into a first group of channels situated within a cartridge having a plurality of channels designed to remove particulates from the fluid flow;
a second manifold having a first reservoir configured to receive and redirect the fluid flow from the first group of channels into a second group of channels situated in the cartridge; and
an outlet extending through the first or second manifold to exit a fluid concentrate from the system, wherein the fluid concentrate comprises a portion of the fluid flow including the particulates removed by the channels.

22. The system of claim 21, wherein the first and second groups of channels have the same number of channels.

23. The system of claim 21, wherein the first and second groups of channels have a different number of channels.

24. The system of claim 21, wherein at least one of the plurality of channels includes a molecular separation membrane positioned on an inner or outer surface of the channel.

25. The system of claim 21, wherein the system comprises an odd number of reservoirs defined on the first and/or second manifold, and the outlet extends through the second manifold.
